(19) United States
(12) Patent Application Publication
(10) Pub. No.: US 2014/0289953 A1
(43) Pub. Date: Oct. 2, 2014

(54) Pool Crane Rotation Apparatus

(71) Applicant: Global Lift Corporation, Bad Axe, MI (US)

(72) Inventors: Joshua Steinman, Pigeon, MI (US); Lee Steinman, Pigeon, MI (US); Dale Steinman, Pigeon, MI (US)

(21) Appl. No.: 14/358,350

(22) PCT Filed: Nov. 15, 2012
(86) PCT No.: PCT/US2012/065355

§ 371 Date: May 15, 2014

Related U.S. Application Data
(60) Provisional application No. 61/559,750, filed on Nov. 15, 2011.

(51) Int. Cl. A61G 7/10

(52) U.S. Cl. CPC A61G 7/1005; A61G 7/1076
USPC 4/496

(57) ABSTRACT

An apparatus for rotating a crane for hoisting and moving a disabled person between a pool and an adjacent deck. The apparatus may include a post receptacle supported adjacent a pool and a post having a lower portion removably receivable in the post receptacle. The post may also have an upper portion that extends upward from the post receptacle when the lower portion of the post is received in the post receptacle. A turret sleeve may be supported on the post upper portion for rotation about a turret axis, and a turret arm may be carried by and extend radially outward from the turret sleeve. A seat may be carried by the arm. A turret driver may be operatively connected to the turret sleeve and configured to rotate the turret, arm, and seat about the turret axis. The apparatus may also include a remote controller configured to command the driver to rotate the turret, arm and seat about the turret axis.

### TECHNICAL FIELD

This application relates generally to moving a disabled person between a pool and an adjacent deck.

### BACKGROUND

The Americans with Disabilities Act (ADA) sets forth standards and requirements regarding the accessibility of swimming pools to handicapped or disabled persons. Public pools are required to have at least one method of disabled access, commonly manifested in the form of a ramp or lift, and the act describes extensive systems, design, and operation specifications required for a lift device to be considered ADA compliant. Common lift engineering challenges include securing the lift to the ground, transporting the lift between storage and use locations, providing a strong and steady drive system to operate the lift, stabilizing the lift's chair to remain upright during deployment, and incorporating safety systems.

### SUMMARY

A pool crane rotation apparatus is provided for rotating an arm portion of a crane-type lift for hoisting and moving a disabled person between a pool and an adjacent deck. The apparatus includes a post receptacle supported in a generally vertical orientation adjacent a pool. The apparatus also includes a generally vertically-oriented metal post having a lower portion configured to be removably receivable in the post receptacle and having an upper portion that extends upward from the post receptacle when the lower portion of the post is received in the post receptacle. A turret is carried by the post upper portion and is supported on the post upper portion for rotation about a generally vertical turret axis. An arm is carried by and extends radially outward from the turret, and a seat is carried by the arm. A control interface is connected to the turret driver and is configured to command the driver to rotate the turret, arm and seat about the turret axis in response to operator inputs to the control interface. The turret comprises a sleeve disposed coaxially around the upper portion of the post and supported for rotation about the turret axis relative to the post. A driver is operatively connected to the sleeve to drive such rotation, and the post upper portion is configured to be received within the turret sleeve and to support the turret sleeve for rotation about the turret axis.

### BRIEF DESCRIPTIONS OF THE DRAWINGS

These and other features and advantages of the invention will become apparent to those skilled in the art in connection with the following detailed description, drawings, photographs, and appendices, in which:

FIG. 1 is a perspective view of a pool crane comprising a pool crane rotation apparatus;

FIG. 2 is a fragmentary magnified perspective view of the pool crane of FIG. 1 with a cover of the pool crane rotation apparatus removed;

FIG. 3 is a top view of the pool crane rotation apparatus of FIG. 2;

FIG. 4 is a cross-sectional side view of the pool crane rotation apparatus of FIG. 2 taken along line 4-4 of FIG. 3 and showing the pool crane rotation apparatus mounted in a receptacle in a pool deck;

FIG. 5 is a cross-sectional top view of the pool crane rotation apparatus, receptacle, and pool deck of FIG. 4 taken along line 5-5 of FIG. 4; and

FIG. 6 is a cross-sectional top view of the pool crane rotation apparatus of FIG. 4 taken along line 6-6 of FIG. 4.

### DETAILED DESCRIPTION

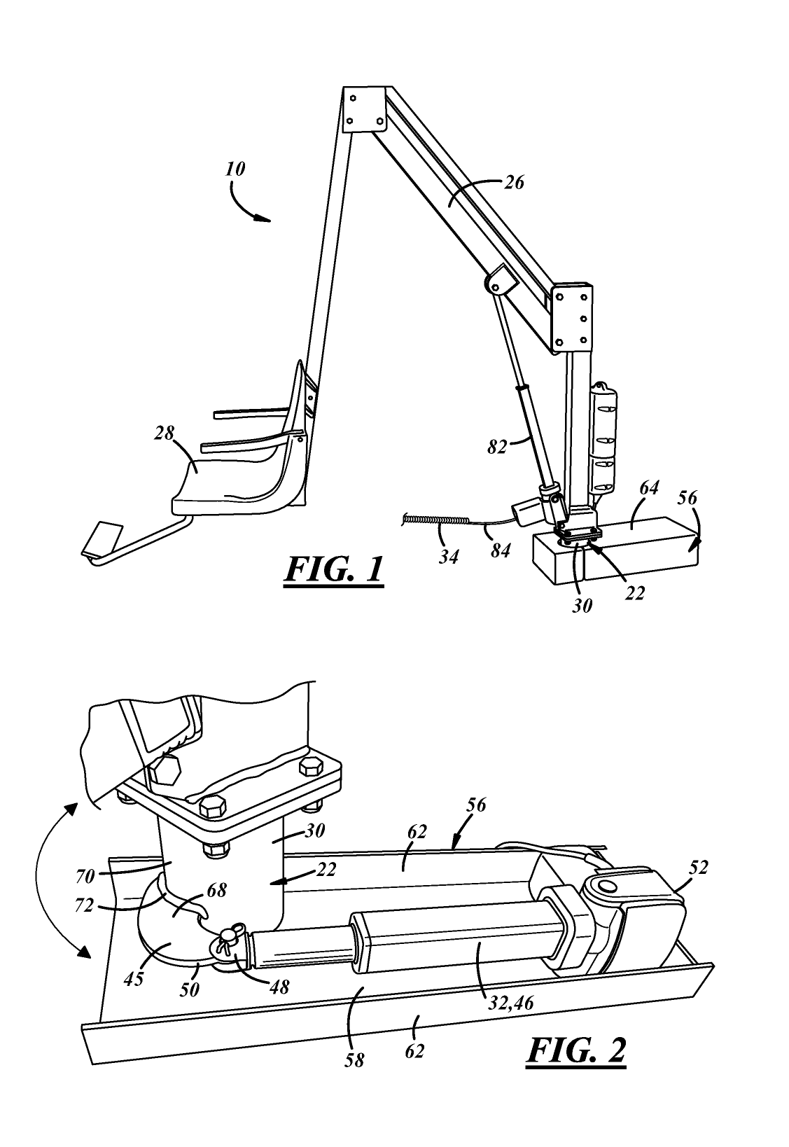

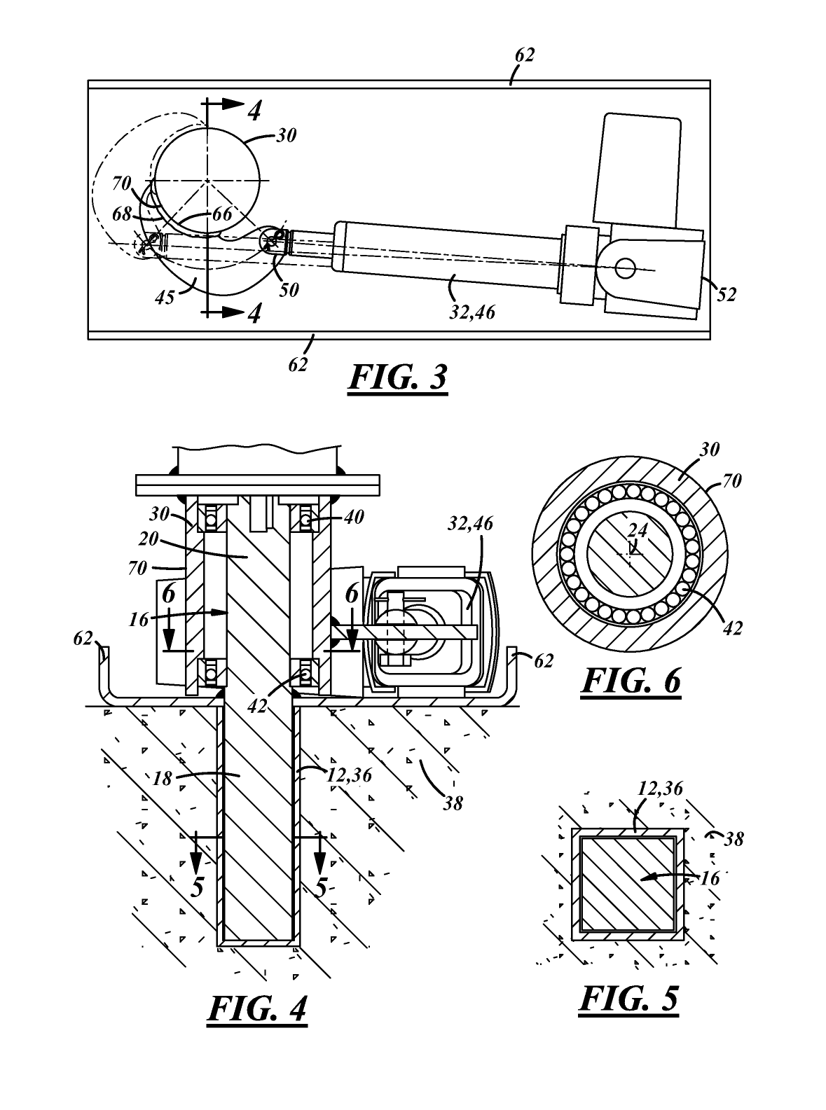

A pool crane rotation apparatus for rotating an arm portion of a crane-type lift for hoisting and moving a disabled person between a pool and an adjacent deck is generally shown at 10 in FIG. 1. The apparatus 10 may include a post receptacle 12 supported in a generally vertical orientation adjacent a pool (a pool being defined as an open-topped fluid receptacle such as an above or below-ground swimming pool or spa). As best shown in FIG. 4, the apparatus 10 may also include a generally vertically-oriented metal post 16 having a lower portion 18 that may be removably receivable in the post receptacle 12 and that may have an upper portion 20 that extends upward from the post receptacle 12 when the lower portion 18 of the post 16 is received in the post receptacle 12.

As best shown in FIG. 4, the upper post portion 20 may carry and support a turret 22 for rotation about a generally vertical turret axis 24. As shown in FIG. 1, the turret 22 may carry a crane arm 26 that may extend radially outward from the turret 22 and that may carry a seat 28 adjacent an outer end of the crane arm 26. As shown in FIG. 4, the turret 22 may comprise a sleeve 30 disposed coaxially around the upper portion 20 of the post 16. The sleeve 30 may be supported for rotation about the turret axis 24 relative to the post 16 and a turret driver 32 may be operatively connected to the turret sleeve 30 and configured to rotate the turret 22, crane arm 26, and seat 28 about the turret axis 24 relative to the post 16. As shown in FIG. 1, a control interface 34 may be connected to the turret driver 32 and may be configured to command the driver 32 to rotate the turret 22, crane arm 26, and seat 28 about the turret axis 24 in response to operator inputs to the control interface 34.

The post receptacle 12 may comprise a hollow post receptacle sleeve 36 that may be formed, inserted, or otherwise supported in a concrete pool deck 38 adjacent a pool as shown in FIGS. 4 and 5. The lower portion 18 of the post 16 may be shaped so as to be removably receivable in the post receptacle 12 and the upper portion 20 of the post 16 may extend upward from the post receptacle 12 when the lower portion 18 of the post 16 is received in the post receptacle 12. The post receptacle sleeve 36 may comprise a generally square metal tube, and the post lower portion 18 may be shaped as a rectangular prism having a generally square transverse cross-section slightly smaller than that of the post receptacle sleeve 36 so as to be removably receivable in the post receptacle sleeve 36.

As shown in FIG. 4, the turret sleeve 30 may comprise a hollow, generally circular (i.e., “round”), tubular metal sleeve of circular cross-section. The post upper portion 20 may be shaped as a solid or hollow cylinder, and sized and otherwise configured to be received within the turret sleeve 30 and to support the turret sleeve 30 for rotation about the turret axis 24. The turret 22 may include upper and lower bearings 40, 42 disposed between the turret 22 and the post upper portion 20 in respective positions to cooperate in supporting the turret 22 upon the post upper portion 20 for rotation about the turret axis 24. In other embodiments rotation of the turret 22 on the post upper portion 20 may be facilitated by any suitable means known in the art to include the incorporation of a hollow, generally circular tubular bushing of circular cross-section within the turret sleeve 30 to support the turret sleeve 30 for rotation about the turret axis 24. In embodiments where such a bushing is employed, the bushing may comprise brass, and may be shaped, sized, and otherwise configured to be received on, and fixed against rotation relative to, the post upper portion 20. Such a bushing may include an annular flange extending radially and integrally outwardly from a lower end of the bushing and configured to engage and support a lower rim of the turret sleeve 30.

The turret 22 may also comprise a load lever arm 45, shown in FIGS. 2 and 3, that may be fixed to, and extend radially outwardly from the sleeve 30. The turret driver 32 may be connected between the load lever arm 45 and the sleeve 30. The driver 32 may comprise a linear actuator 46 having a forward end 48 pivotably connected to a radially outer end 50 of the load lever arm 45. A back end 52 of the linear actuator 46 may be pivotably connected and/or connectable to a stationary support 54 spaced from the post 16. In the present embodiment the back end 52 of the linear actuator 46 is pivotably connected to a support 54 carried by a base 56 of the apparatus 10. However, in other embodiments, the back end 52 may be pivotably connected to any stationary support spaced from the post 16, to include a support carried by and fixed to a nearby structure such as the pool deck 38 supporting the apparatus 10. The linear actuator 46 may be used to control the rotational position of the turret 22, crane arm 26, and seat 28 by alternately pushing and pulling the load lever arm 45 along a circumferential path radially spaced from the turret axis 24.

As shown in FIGS. 2-4, the apparatus 10 base 56 may be fixed to the lower portion 18 of the post 16. The base 56 may include a base plate 58 positioned and shaped to lie flat on a pool deck 38 that's carrying the post receptacle sleeve 36. The back end 52 of the linear actuator 46 may be pivotably connected to a crosspiece 60 projecting upward from the base plate 52. The base plate may include side walls 62 that integrally extend upward from along opposite sides of the base plate 58, and the base 56 may include a removable cover 64 that cooperate with the base plate 58 to enclose the linear actuator 46 within the base 56 in a horizontal orientation to provide a low-profile means of housing the turret driver 32.

As shown in FIGS. 2 and 3, the load lever arm 45 may have a lobular shape configured to distribute loads transmitted from the outer end 50 of the lever arm 45 to and along the circumferential interface 66 at an inner end 68 of the load lever arm 45. The load lever arm's inner end 68 may be shaped to form an approximate 180 degree inner circumferential interface 66 with an outer circumferential surface 70 of the turret sleeve 30 to distribute torque loads applied by the linear actuator 46 through the load lever arm 45 to the turret sleeve 30. The circumferential interface 66 may comprise a weld joint 72 extending along a length of the circumferential interface 66.

As shown in FIG. 1, the crane arm 26 may be articulated such that it may be extended radially outward and retracted radially inward relative to the turret axis 24. The apparatus 10 may include an arm driver 82 operatively connected to the crane arm 26 to extend and retract the crane arm 26.

The control interface 34 may be connected to the arm driver 82 and/or the turret driver 32 and may be configured to command the arm driver 82 to move the crane arm 26 in extension and retraction and/or to command the turret driver 32 to rotate the crane arm 26 and seat 28 about the turret axis 24. The control interface 34 may be a remote control interface connected by a cable 84 comprising current pathways for transmitting electrical signals and/or power between the remote control interface 34 and the arm driver 82. However, in other embodiments the control interface 34 may include any other suitable means known in the art for remotely controlling the turret driver 32 and/or the arm driver 82. The apparatus 10 may thus be operated either by an occupant of the chair or by a bystander.

A pool crane rotation apparatus constructed as described above may be used to safely convey a disabled person between a pool and an adjacent deck under the control of either the occupant of the chair or a bystander. The linear actuator and load lever arm described above provide a strong and stable means of controlling rotation of the apparatus, and is considerably more robust and provides a more positive connection than is provided by geared linkages known in the art.

This description, rather than describing limitations of an invention, only illustrates an embodiments of the invention recited in the claims. The language of this description is therefore exclusively descriptive and is non-limiting.

What is claimed is:

1. A pool crane rotation apparatus for hoisting and moving a person between a pool and an adjacent deck, the apparatus comprising:
a post receptacle supported adjacent a pool;
a post having a lower portion configured to be removably receivable in the post receptacle and having an upper portion that extends upward from the post receptacle when the lower portion of the post is received in the post receptacle;
a turret carried by the post upper portion and supported on the post upper portion for rotation about a turret axis;
an arm carried by and extending radially outward from the turret, a seat carried by the arm, a turret driver operatively connected to the turret and configured to rotate the turret, arm, and seat about the turret axis relative to the post;
a control interface connected to the turret driver and configured to command the driver to rotate the turret, arm and seat about the turret axis in response to operator inputs to the control interface; and
the turret comprising a sleeve disposed coaxially around the upper portion of the post and supported for rotation about the turret axis relative to the post, the driver being operatively connected to the sleeve to drive such rotation, and the post upper portion being configured to be received within the turret sleeve and to support the turret sleeve for rotation about the turret axis.

2. A pool crane rotation apparatus as defined in claim 1 in which:
the post receptacle comprises a hollow post receptacle sleeve configured to be supported in a pool deck adjacent a pool; and
the post comprises:
a lower portion shaped so as to be removably receivable in the post receptacle, and
an upper portion that extends upward from the post receptacle when the lower portion of the post is received in the post receptacle.

3. A pool crane rotation apparatus as defined in claim 2 in which:
the post receptacle sleeve comprises a generally rectangular tube; and
the post lower portion is shaped as a rectangular prism having a generally rectangular transverse cross-section slightly smaller than that of the post receptacle sleeve so as to be removably receivable in the post receptacle sleeve.

4. A pool crane rotation apparatus as defined in claim 2 in which:
the turret comprises a hollow generally circular tubular turret sleeve; and
the post upper portion is configured to be received within the turret sleeve and to support the turret sleeve for rotation about the turret axis.

5. A pool crane rotation apparatus as defined in claim 4 in which the turret includes at least one bearing disposed between the turret sleeve and the post upper portion in a position to rotatably support the turret sleeve for rotation about the turret axis on the post upper portion.

6. A pool crane rotation apparatus as defined in claim 5 in which the bushing comprises brass.

7. A pool crane rotation apparatus as defined in claim 1 in which:
the arm is an articulated arm configured to extend radially outward and to retract radially inward relative to the turret axis; and
the apparatus includes an arm driver operatively connected to the arm and configured to extend and retract the arm.

8. A pool crane rotation apparatus as defined in claim 7 in which the control interface is connected to the arm driver and is configured to command the arm driver to command arm extension and retraction.

9. A pool crane rotation apparatus as defined in claim 8 in which the control interface is a remote control interface connected to the turret driver and the arm driver.

10. A pool crane rotation apparatus as defined in claim 4 in which:
the turret comprises a load lever arm fixed to and extending radially outwardly from the sleeve; and
the driver comprises a linear actuator connected to the load lever arm and configured to control the rotational position of the turret, crane arm, and seat by alternately pushing and pulling the load lever arm along a circumferential path radially spaced from the turret axis

11. A pool crane rotation apparatus as defined in claim 10 in which an inner end of the load lever arm is shaped to form an inner circumferential interface with an outer circumferential surface of the turret sleeve.

12. A pool crane rotation apparatus as defined in claim 11 in which the circumferential interface comprises a weld joint.

13. A pool crane rotation apparatus as defined in claim 11 in which the load lever arm has a lobular shape configured to distribute loads transmitted from the outer end of the lever arm to and along the circumferential interface at the inner end of the load lever arm.

14. A pool crane rotation apparatus as defined in claim 2 in which:
the apparatus includes a base fixed to the lower portion of the post; and
the linear actuator is pivotably connected to the base.
